(19) United States
(12) Patent Application Publication
(10) Pub. No.: US 2009/0147669 A1
(43) Pub. Date: Jun. 11, 2009

(54) CONTINUOUS PHASE MODULATION ENCODER FOR WIRELESS NETWORKS

(75) Inventor: Marilynn P. Green, Coppell, TX (US)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 11/953,488

(22) Filed: Dec. 10, 2007

(51) Int. Cl. H04L 5/12

(52) U.S. Cl. 370/215

(57) ABSTRACT

Various example embodiments are disclosed herein. According to an example embodiment, an apparatus for use in a wireless transmitter may include a phase encoder adapted to generate a continuous time signal based on a symbol and a corresponding modulation index for a current symbol interval and one or more previous symbol intervals and based on a continuous phase modulation (CPM) phase response function, a filter and symbol-rate sampler adapted to filter and then symbol rate sample the continuous time signal to generate a symbol-rate statistic that is representative of the continuous time signal for each of the symbol intervals; a mapping circuit adapted to map each of the plurality of symbol-rate statistics to a corresponding constant modulus CPM symbol, and a transmitter circuit adapted to transmit a signal based on the constant modulus CPM symbols.

### TECHNICAL FIELD

This description relates to wireless networks.

### BACKGROUND

Orthogonal Frequency Division Multiplexing (OFDM) is a linear modulation scheme in which a set of orthogonal subcarriers are used to carry user data. OFDM can be efficiently implemented using Fourier transforms, such as the Fast Fourier Transform (FFT) and can be designed to be especially robust to multipath. Low complexity frequency domain equalization algorithms can be used to mitigate the impact of the channel. OFDM may provide a spectrally efficient scheme in which the subcarriers can overlap but remain orthogonal (in the absence of synchronization errors).

OFDMA (orthogonal frequency division multiple access) is an extension of OFDM in which multiple users share the same transmission band. OFDMA is a multi-user version of the OFDM modulation scheme. The multiple access feature is achieved in OFDMA by assigning subsets of the subcarriers to individual users, and allows the simultaneous low data rate transmission from several users over the same band. In conventional OFDMA, a different number of the available sub-carriers can be assigned to different users, in order to support differentiated quality of service (QoS).

A disadvantage of multi-carrier modulation, such as OFDM or OFDMA, is that it can exhibit high peak-to-average power ratio (PAPR), where the peak value of the signal can be much larger than the average (typical) value. For example, the peak value of an OFDM waveform may typically grow linearly with the number of subcarriers because for some OFDM symbols, all of the subchannel waveforms can potentially add up together in phase at some time during the transmission. This may require the use of circuits with linear characteristics over a large dynamic range, such as linear power amplifiers. However, most power amplifiers may be most power-efficient when they are operating in a saturation (or nonlinear) region. In general, linear power amplifiers are less efficient, more expensive, and often require larger areas (for heat dissipation) than their nonlinear counterparts. Furthermore, clipping the signal at high levels may occur which may distort the information-bearing amplitude of the signal and yields out-of-band radiation, and which may degrade bit error rate (BER) performance of the system.

### SUMMARY

According to an example embodiment, a method may include generating a continuous time signal based on a symbol and a corresponding modulation index for a current symbol interval and one or more previous symbol intervals and based on a continuous phase modulation (CPM) phase response function; filtering and then symbol rate sampling the continuous time signal to generate a symbol-rate statistic that is representative of the continuous time signal for each of the symbol intervals; mapping each of the plurality of symbol-rate statistics to a corresponding constant modulus CPM symbol; and transmitting a signal based on the constant modulus CPM symbols.

According to another example embodiment, an apparatus for use in a wireless transmitter may include a phase encoder adapted to generate a continuous time signal based on a symbol and a corresponding modulation index for a current symbol interval and one or more previous symbol intervals and based on a continuous phase modulation (CPM) phase response function; a filter and symbol-rate sampler adapted to filter and then symbol rate sample the continuous time signal to generate a symbol-rate statistic that is representative of the continuous time signal for each of the symbol intervals; a mapping circuit adapted to map each of the plurality of symbol-rate statistics to a corresponding constant modulus CPM symbol; and a transmitter circuit adapted to transmit a signal based on the constant modulus CPM symbols.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a block diagram of a wireless transmitter according to an example embodiment.

FIG. 3 is a flow chart illustrating operation of a wireless node according to an example embodiment.

FIG. 4 is a block diagram of a wireless node according to an example embodiment.

### DETAILED DESCRIPTION

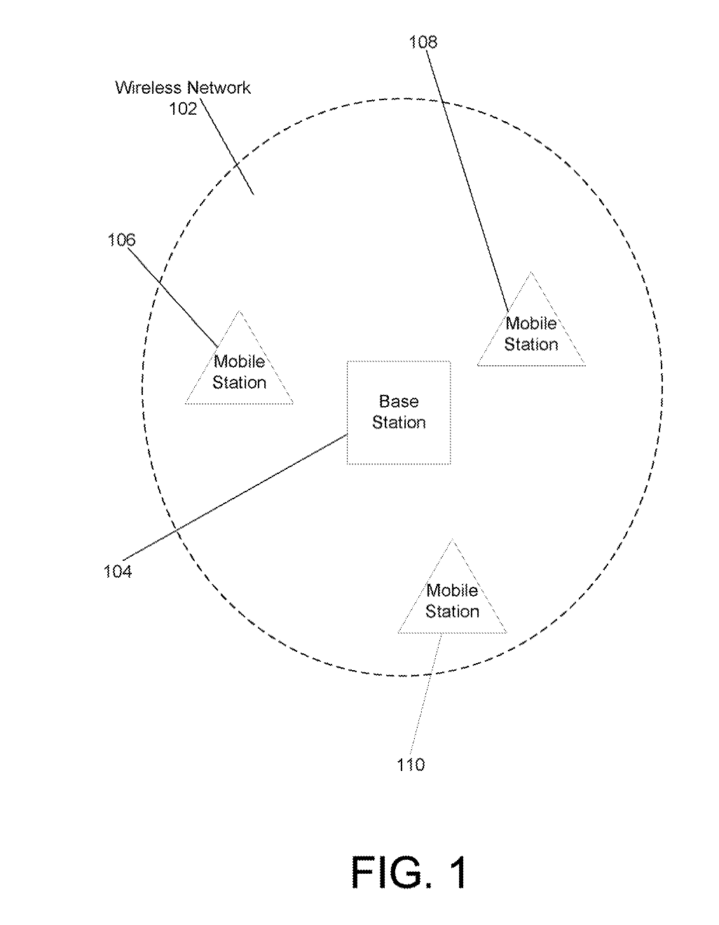

FIG. 1 is a block diagram of a wireless network 102 including a base station 104 and three mobile stations 106, 108, 110 according to an example embodiment. Although not shown, mobile stations 106, 108 and 110 may be coupled to base station 104 via relay stations or relay nodes, for example. The wireless network 102 may include any wireless network, such as, for example, an IEEE 802.16 Worldwide Interoperability for Microwave Access (WiMAX) network, an IEEE 802.11 Wireless Local Area Network (WLAN), or a cellular telephone network, a network based on 3GPP (Third Generation Partnership Project), based on LTE (Long Term Evolution), or other wireless network.

The base station 104 may include a cellular or WiMAX base station (BS), a node B, an 802.11 access point, or other infrastructure node, according to various example embodiments. The term “base station” (BS) may be used herein and may include any type of infrastructure node. The mobile stations 106, 108, 110 may include laptop or notebook computers, smartphones, personal digital assistants (PDAs), cellular telephones, WiMAX device, subscriber station, or any other wireless device, according to example embodiments. The term “wireless node” may include any type of wireless node, such as base stations, mobile stations, etc. While the present disclosure may use some of the terminology of WiMax or other wireless standards, aspects of the present disclosure may be applicable to any networking or wireless technologies.

Continuous phase modulation (CPM) is a nonlinear modulation scheme in which the information symbols are used to modulate the phase of a complex exponential, for example. According to an example embodiment, a wireless transmitter may be provided that may combine a CPM modulator with a multicarrier (e.g., OFDM or OFDMA) wireless transmission system (or transmitter) while retaining the orthogonal multicarrier properties and while accommodating multiple users. In an example embodiment, a CPM modulator or CPM encoder may be provided that generates complex-valued symbol-rate statistics, each of which may provide a symbol-rate statistic for each symbol interval from a continuous time CPM signal or waveform. Some general properties of a CPM system will first be described, followed by some example embodiments in which CPM modulator and a multicarrier (OFDM or OFDMA) transmission scheme are combined in a wireless transmitter.

Continuous phase modulation (CPM) may be a power and bandwidth-efficient scheme, and may have several parameters which can be selected to shape the spectrum. An advantage of CPM is that the transmitted signal or waveform output by a CPM modulator has a relatively low peak-to-average power ratio (PAPR). The output of a CPM modulator may typically have a constant envelope, meaning that the peak-to-average power ratio (PAPR) is typically unity or 1 (in linear units), or 0 dB. Thus, with CPM, nonlinear power amplifiers, which are typically more efficient and less expensive than traditional linear amplifiers, may be employed without substantially distorting the information-bearing portion of the transmitted signal or waveform, since the information is carried in the phase of the signal. Thus, CPM may be an attractive candidate for some applications, such as uplink transmissions from wireless mobile devices (e.g., cell phones, WiMAX devices, PDAs and other mobile or wireless devices) where battery life is a key concern.

For example, Bluetooth devices are typically required to be compact and battery efficient. The modulation format used in Bluetooth is Gaussian frequency-shift keying (GFSK), which is a modulation format belonging to the family of CPMs. Other popular standards or applications where CPM has been adopted are GSM, Hyperlan, DECT, satellite communications, and land-mobile radio.

According to an example embodiment, a hybrid modulation scheme may be provided that combines elements from orthogonal transmission systems, such as single carrier-Orthogonal Frequency Division Multiplexing (SC-OFDM) and CPM in order to design a more power efficient multiple access system. As in OFDM or OFDMA, the transmissions take place over orthogonal frequency channels. In addition, a new CPM encoder (CPMe) is provided that generates complex-valued symbol-rate statistics from a continuous-time CPM waveform (continuous time signal generated based on a CPM phase response function). These CPM (or CPMe) symbols are then processed and mapped to the allocated orthogonal frequencies or subcarriers, e.g., for SC-OFDM transmission over the wireless channel.

CPM is a modulation scheme in which the information symbols are used to modulate the phase of a complex exponential. A CPM transmitter, or a CPM modulator, may have several modulation parameters which can be selected in order to shape the spectrum. The CPM waveform may operate or change, as a finite state machine, where the phase output by the CPM for the current (or kth) symbol may be a function of the current (or kth) symbol and L-1 previous symbols, for example.

Over the generic kth symbol interval, the complex envelope of a unit amplitude CPM waveform is given by

s(t;α)=e^{jφ(t;α)} (1)

kT≦t<(k+1)T

where T denotes the symbol duration. α={ . . . α₀, α₁, . . . } represents the M-ary information sequence (αᵢ ε {±1,±3 . . . ,±(M-1)}, which modulates the phase term φₖ (t;α) as follows:

$$φ ( t ; α ) = {θ}_{k - L} + 2 π h {\sum }_{i = 0}^{L - 1} {α}_{k - i} q ( τ + iT ) . \qquad ( 2 )$$

The CPM phase shaping function (or CPM phase response function) q(t) may be defined as the integral of the frequency-shaping pulse, f(t)

q(t)=^{t}∫₀f(τ)dτ (3)

where f(t) is of duration LT and is normalized such that q(LT)=½. When L=1, the CPM waveform exhibits full response and for L>1, it is partial response, where L is a signal correlation length. The cumulative phase term

$${θ}_{k - L} = π h {\sum }_{i = 0}^{k - L} {α}_{i}$$

mod2π represents the contribution of all of the past symbols (e.g., symbols older than L-1) for which the phase shaping function has reached its constant value of ½. Finally, h=K/P is the modulation index (K and P being relatively prime integers).

Using this signal construction, it is clear that for rational h, that the phase evolution of CPM can be represented using a finite state machine, and that over any symbol interval it is completely characterized by the current input symbol, αₖxₖ, and an L-tuple state vector that may be defined as follows:

σₖ={θ_{k-L},α_{k-(L-1}, . . . ,α_{k-1}} (4)

In conventional CPM, the input symbols are drawn from the M-ary alphabet {±1,±3, . . . ,±(M-1)} and the corresponding correlative state vector {α_{k-(L-1)}, . . . ,αₖ₋₁} is drawn from a set of cardinality M^{L-1}. The number of possible values of θ_{k-L} is equal to 2P when Q is odd and P when Q is even. When Q is odd, then θ_{k-L} can assume P of its values during the kth interval and the other P values during the k+1^{st} interval. Hence, the trellis is generally time-varying, but during any particular symbol interval, the state vector is drawn from a set of cardinality PM^{L}. The application of the Rimoldi's tilted phase decomposition to the signal model is generally used to yield a time-invariant phase space for CPM.

From Equation (1), CPM is a constant envelope scheme:

|s(t;α)|²=1. (5)

This implies that its PAPR (peak-to-average-power ratio) is typically equal to 0 dB. This is easily shown as, for example, the PAPR is expressed as

$$P A P R = \frac{Peak power of s ( t ; α )}{Average power of s ( t ; α )} = \frac{{max}_{0 \leq t \leq KT} {\vert s ( t ; α ) \vert}^{2}}{\frac{1}{KT} {\int }_{0}^{KT} {\vert s ( t ; α ) \vert}^{2} d t} \qquad ( 6 )$$

Considering the constant envelope characteristic of CPM, it is easily shown that

$$P A P {R}_{CPM} = \frac{1}{1} = 1 \\ 10 {log}_{10} ( P A P {R}_{CPM} ) = 0 dB \qquad ( 7 )$$

Hence, for substantially all (or all) M-ary modulations and complexities of the CPM waveform, its PAPR is typically 0 dB. As noted above, it is this 0 dB PAPR of a CPM waveform that advantageously may allow use of nonlinear amplifiers and circuits, which may be, at least in some cases, more efficient and less expensive than linear amplifiers/circuits.

According to an example embodiment, CPM encoding (CPMe) is introduced or provided for orthogonal subcarrier transmission, such as for a SC-FDMA transmission scheme. For example, CPMe may be used to transmit data in the uplink direction (subscriber or mobile station to base station/access point). However, this encoder may also be used for downlink transmissions.

In this scenario, a single user may have been allocated a total of N subcarriers in order to transmit N information symbols for an uplink transmission. The total number of subcarriers is equal to M (M>N) and the subcarrier mapping scheme is arbitrary—that is, the user is assigned to an arbitrary subset (of size K) of the total number of subcarriers (of size M). The other subcarriers are assigned to other users.

According to an example embodiment, the output of a CPM modulator may be modified over N symbol intervals such that the output of the CPMe may be a sequence of N complex symbols which are representative of the driving waveform (continuous time signal) over the entire observation interval.

Over the k^{th} symbol interval, the instantaneous phase of the of a generic CPM waveform (continuous time signal φₖ) may be expressed as follows:

$${φ}_{k} ( t ; α ) = {θ}_{k - L} + 2 π {\sum }_{i = 0}^{L - 1} {h}_{k - i} {α}_{k - i} q ( τ + i T ) ; \\ t = kT + τ ; 0 \leq τ < T . \qquad ( 8 )$$

The instantaneous phase may typically be a real-valued, continuous-time waveform. As such, in order to integrate CPMe into an SC-FDMA architecture, a discrete representation of the instantaneous phase may be provided, which can produce complex symbols at the symbol rate (T being the symbol interval, and 1/T being the symbol rate). In an example embodiment, it may be desirable to construct a sufficient statistic for estimating the information sequence (continuous time signal). Thus, CPM encoding may be performed based on the instantaneous phase of the CPM waveform in order to generate a symbol-rate statistic. In one example embodiment, this may be realized as a filter matched to q(t), followed by a sampler operating at the symbol rate 1/T. Consequently, the sampled symbol-rate statistics xₖ at the output of the matched filter may be defined as

$$\begin{matrix}{x}_{k} = \frac{{\int }_{0}^{T} {φ}_{k} ( τ ; α ) q ( τ ) d τ}{{\int }_{0}^{T} q ( τ ) d τ} \\ = {θ}_{k - L} + \frac{2 π {\sum }_{i = 0}^{L - 1} {h}_{k - i} {α}_{k - i} {\int }_{0}^{T} q ( τ + i T ) q ( τ ) d τ}{{\int }_{0}^{T} q ( τ ) d τ}\end{matrix} \qquad ( 3 )$$

for k=0, . . . ,K-1 . Let us now define the quantity

$${v}_{i} = \frac{{\int }_{0}^{T} q ( τ + i T ) q ( τ ) d τ}{{\int }_{0}^{T} q ( τ ) d τ} \qquad ( 4 )$$

Then the symbol-rate statistic simplifies to the following

$${x}_{k} = {θ}_{k - L} + 2 π {\sum }_{i = 0}^{L - 1} {h}_{k - i} {α}_{k - i} {v}_{i} \qquad ( 5 )$$

The sequence of symbol-rate statistics {xₖ} now represents the input to a phase modulator, which produces the complex constellation symbol

sₖ=e^{jx}^{ₖ} (6)

which has constant amplitude. The trellis structure of the original CPM waveform is also present in this complex symbol since the value of sₖ depends not only on the current (kth) data symbol but on past data (previous symbols). In addition, there is also an influence on the properties of this constellation from the pulse shaping filter (or CPM phase response function) q(t), the correlation length (L) and the modulation index(es) (h).

Thus, according to an example embodiment, by generating a sequence of symbol-rate statistics xₖ from the instantaneous phase of a continuous-time CPM waveform φₖ, this may provide a discrete set of CPM symbols which retain many of the excellent characteristics of CPM, and may be applied to one or more orthogonal carriers or subcarriers for transmission, as described in greater detail below. This is a new technique of combining CPM and OFDM and which may be used to reduce the bit error rate (BER) and to reduce the PAPR when compared to more traditional schemes, such as quadrature phase-shift keying (QPSK) SC-FDMA, etc.

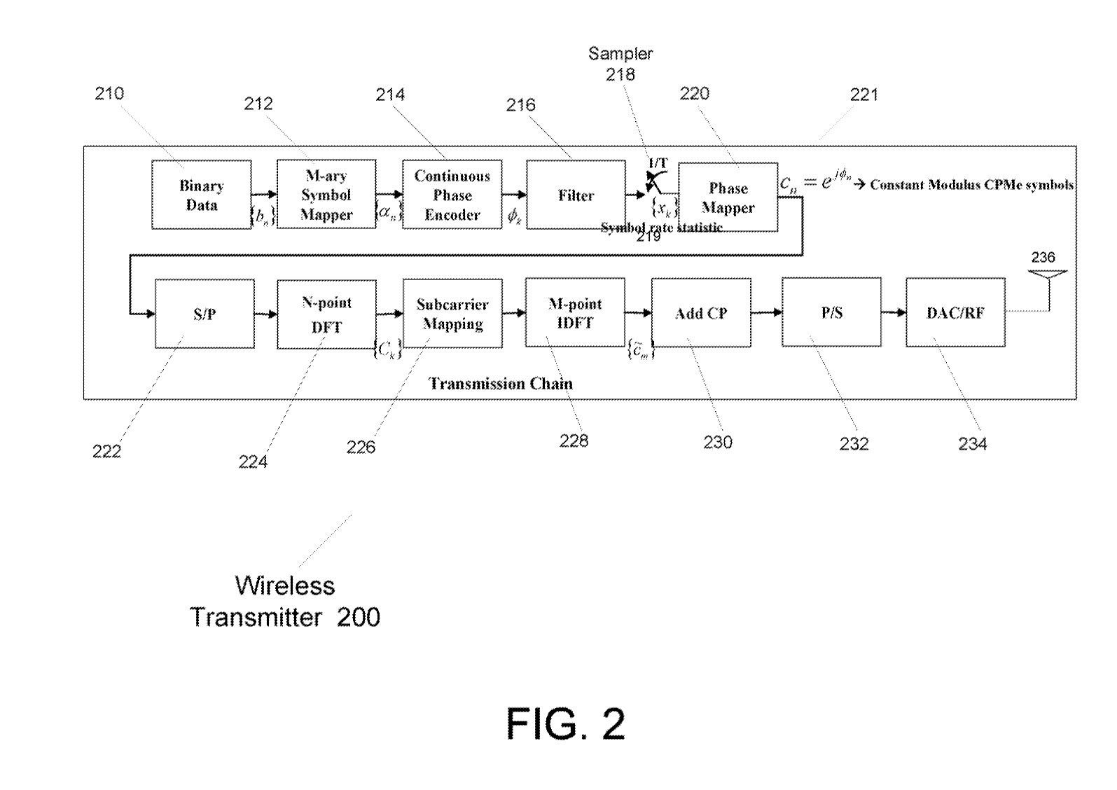

FIG. 2 is a block diagram of a wireless transmitter according to an example embodiment. The wireless transmitter 200 may be provided, for example, within a wireless transceiver (transmitter/receiver) of a wireless mobile station, base station/access point, or any other wireless device. Referring to wireless transmitter 200, binary data (bₙ) or one or more bits may be mapped by M-ary symbol mapper 212 to one or more (or a sequence of) symbols αₙ.

A continuous phase encoder 214 may encode or generate a continuous time signal based on a symbol a and a corresponding modulation index h for a current (e.g., kth) symbol interval and one or more previous symbol intervals, and also based on a continuous phase modulation (CPM) phase response function q(t). In an example embodiment, the continuous time signal may be generated based on a sum of products over a range of symbol intervals, where each product is a product of a symbol α and a corresponding modulation index h and the continuous phase modulation (CPM) phase response function q(t).

The CPM phase response function q(t) may be used to provide a continuous signal and to shape the spectral properties of the received symbols, e.g., to provide a more efficient use of spectral resources and/or to decrease bit error rate (BER), for example.

A constant modulation index h may be used for (or over) a plurality of symbol intervals. Alternatively, a set (or plurality) of modulation indices may be used, e.g., a set of M modulation indices may be used over a sequence of symbol intervals, and then repeated. Multiple modulation indices h may be used, for example, to control or improve bit error rate (BER), and/or to improve use of spectral resources, (e.g., by controlling a maximum phase deviation).

In an example embodiment, the CPM phase response function q(t) may be a time varying function for the first (or most recent) L symbols, after which, older symbols may become a constant, such as ½. In an example embodiment, the continuous phase encoder 214 may generate a continuous time signal φₖ based approximately on the following equation:

$${φ}_{k} ( t ; α ) = {θ}_{k - L} + 2 π {\sum }_{i = 0}^{L - 1} {h}_{k - i} {α}_{k - i} q ( τ + i T ) ;$$

t=kT+τ0≦τ≦T., where hₖ is the modulation index for the kth symbol interval, αₖ is the symbol for the kth symbol interval, and q is the continuous phase modulation (CPM) phase response function, and wherein θ_{k-L} represents the contribution for symbols older than L-1.

A filter 216 may filter the continuous time signal φₖ(t;α). In an example embodiment, filter 216 may be a matched filter that is matched (or approximately matched) to the CPM phase response function q(t) to generate an filtered signal that is sampled by sampler (or sample and hold circuit) 218 to generate a symbol-rate statistic xₖ for each symbol interval.

It may be desirable to obtain (or provide) one sample of the continuous time signal (or instantaneous phase signal) φₖ(t;α) every symbol interval. As noted above, the continuous time signal φₖ(t;α) is a time varying signal that is a function of the current input symbol αₖ and one or more previous symbols. Simply sampling φₖ(t;α) once every symbol interval may not provide sufficient information that would allow a receiver to accurately reconstruct the information signal (symbols), e.g., some information may be lost in such sampling process, at least in some cases.

As shown in Eqns. (11) and (13), a symbol-rate statistic xₖ is a function of the symbol for the current symbol interval (k) and previous symbol intervals. Eqn. (12) indicates that the calculation for a symbol-rate statistics xₖ is based on a multiplication of q(t), which may be considered to be a correlation. It can be seen that Vᵢ is a maximum for i=0, since this results in q(t) being correlated with itself (see eqn. (12)). The contributions to xₖ from other (previous symbols α, e.g., for i>0) may typically be less than the contribution from the current symbol (i=0), based on the correlation shown in eqn. (12). Thus, according to an example embodiment, filtering and symbol rate sampling (sampling at the symbol rate 1/T) the continuous time signal φₖ(t;α) by a filter 216 that is matched to the CPM phase response function q(t) may provide a symbol-rate statistic xₖ that includes information from the current symbol and from one or more previous symbols, but with the emphasis being on the current symbol (e.g., greater weight on the current symbol in xₖ as compared to previous symbols). Also, filtering φₖ(t;α) by filter 216 may provide a sufficient statistic that sufficiently represents the time varying signal φₖ(t;α), allowing the input information (or original symbols) to be detected or recovered at a receiver, since the symbol-rate statistic xₖ is based on the current symbol and one or more past symbols, and the corresponding modulation index(ices), which may be time varying, for example.

Referring to FIG. 2, the sequence of symbol-rate statistics are input to a phase mapper 220. Phase mapper 220 may map each of the symbol-rate statistics xₖ to a corresponding constant modulus CPM symbol Cₙ 221. The constant modulus CPM symbols 221 are then converted from serial to parallel by serial to parallel converter 222. Fourier Transform block 224 may perform a Fourier Transform, such as a Discrete Fourier Transform, on a group of constant modulus CPM symbols Cₙ 221 to output a group of discrete Fourier coefficients Cₖ. Each of the Fourier coefficients may be mapped to a corresponding orthogonal carrier or subcarrier (e.g., OFDM subcarrier) by subcarrier mapping block 226. Inverse Fourier Transform block 228 may perform an inverse Fourier Transform, such as an inverse Discrete Fourier Transform on the mapped Fourier coefficients to generate a group of time domain coefficients Cₘ. A cyclic prefix (CP) may be added to the block of data by block 230, e.g., to reduce the effects from multipath or inter-symbol interference. The block of data may then be passed through a parallel to serial to generate a serial data stream for transmission. A radio (e.g., radio frequency) transmitter block 234 may then transmit the data stream via a wireless link.

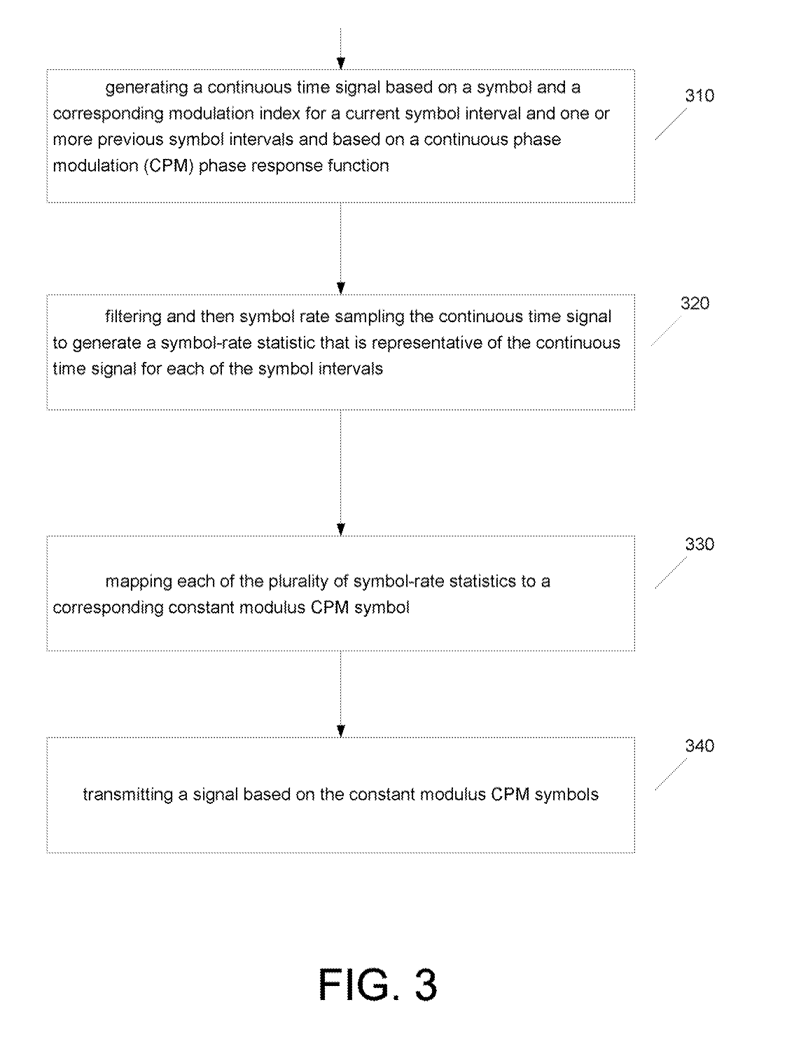

FIG. 3 is a flow chart illustrating operation of a wireless node according to an example embodiment. Operation 310 may include generating a continuous time signal based on a symbol and a corresponding modulation index for a current symbol interval and one or more previous symbol intervals and based on a continuous phase modulation (CPM) phase response function. Operation 320 may include filtering and then symbol rate sampling the continuous time signal to generate a symbol-rate statistic that is representative of the continuous time signal for each of the symbol intervals. Operation 330 may include mapping each of the plurality of symbol-rate statistics to a corresponding constant modulus CPM symbol. Operation 340 may include transmitting a signal based on the constant modulus CPM symbols.

In an example embodiment, operation 310 may include generating a continuous time signal based on a sum of products over a range of symbol intervals, where each product is a product of a symbol and a corresponding modulation index and the continuous phase modulation (CPM) phase response function.

In an example embodiment, operation 310 may include generating a continuous time signal based approximately on the following equation:

$${φ}_{k} ( t ; α ) = {θ}_{k - L} + 2 π {\sum }_{i = 0}^{L - 1} {h}_{k - i} {α}_{k - i} q ( τ + i T ) ;$$

t=kT+τ;0≦τ<T., where hk is the modulation index for the kth symbol interval, αₖ is the symbol for the kth symbol interval, and q is the continuous phase modulation (CPM) phase response function, and wherein θ_{k-L} represents the contribution for symbols older than L-1.

In an example embodiment, in the flow chart of FIG.3, a constant (or same) modulation index may be used for a plurality of the symbol intervals. Alternatively, a different modulation index may be used for each of a plurality of symbol intervals (e.g., a repeating sequence of modulation indices).

In an example embodiment, operation 320 may include correlating the continuous time signal against the CPM phase response function to generate a filtered signal.

In an example embodiment, operation 320 may include filtering and then symbol rate sampling the continuous time signal to generate a symbol-rate statistic that is representative of the continuous time signal for each of the symbol intervals, the filtering being performed using a filter that is substantially matched to the CPM phase response function.

In an example embodiment, operation 320 may include filtering and then symbol rate sampling the continuous time signal approximately based on the following:

$$\begin{matrix}{x}_{k} = \frac{{\int }_{0}^{T} {φ}_{k} ( τ ; α ) q ( τ ) d τ}{{\int }_{0}^{T} q ( τ ) d τ} \\ = {θ}_{k - L} + \frac{2 π {\sum }_{i = 0}^{L - 1} {h}_{k - i} {α}_{k - i} {\int }_{0}^{T} q ( τ + i T ) q ( τ ) d τ}{{\int }_{0}^{T} q ( τ ) d τ} ,\end{matrix}$$

where φₖ is the continuous time signal, hₖ is the modulation index for the kth symbol interval, αₖ is the symbol for the kth symbol interval, and q is the continuous phase modulation (CPM) phase response function.

In an example embodiment, operation 340 may include transmitting a signal including a plurality of orthogonal frequency division multiplexed (OFDM) subcarriers based on the plurality of constant modulus CPM symbols.

In an example embodiment, operation 340 may include performing a Fourier transform on the plurality of constant modulus CPM symbols to generate a group of Fourier coefficients, mapping each of the Fourier coefficients to an orthogonal subcarrier, performing an inverse Fourier transform on the mapped Fourier coefficients to generate a group of time domain samples, and transmitting the group of time domain samples.

According to another example embodiment, an apparatus for use in a wireless transmitter may include a phase encoder adapted to generate a continuous time signal based on a symbol and a corresponding modulation index for a current symbol interval and one or more previous symbol intervals and based on a continuous phase modulation (CPM) phase response function; a filter and symbol-rate sampler adapted to filter and then symbol rate sample the continuous time signal to generate a symbol-rate statistic that is representative of the continuous time signal for each of the symbol intervals; a mapping circuit adapted to map each of the plurality of symbol-rate statistics to a corresponding constant modulus CPM symbol; and a transmitter circuit adapted to transmit a signal based on the constant modulus CPM symbols.

In an example embodiment, the filter and symbol-rate sampler may include a filter adapted to filter the continuous time signal to generate a filtered signal; and a sample and hold circuit adapted to sample the filtered signal at each of a plurality of symbol intervals to generate a symbol-rate statistic for each of the symbol intervals, each symbol-rate statistic representing the continuous time signal for one of the symbol intervals.

In another example embodiment, the filter and symbol-rate sampler may include a filter substantially matched to the CPM phase response, the filter adapted to filter the continuous time signal using generate a filtered signal; and a sample and hold circuit adapted to sample the filtered signal at each of a plurality of symbol intervals to generate a symbol-rate statistic for each symbol interval, each symbol-rate statistic being a sufficient statistic to represent the continuous time signal for one of the symbol intervals.

In an example embodiment, the phase encoder may include a phase encoder adapted to generate a continuous time signal based on a sum of products over a range of symbol intervals, where each product is a product of a symbol and a corresponding modulation index for a symbol interval and based on a continuous phase modulation (CPM) phase response function.

In an example embodiment, the phase encoder may include a phase encoder adapted to generate continuous time signal based approximately on the following equation:

$${φ}_{k} ( t ; α ) = {θ}_{k - L} + 2 π {\sum }_{i = 0}^{L - 1} {h}_{k - i} {α}_{k - i} q ( τ + i T ) ;$$

t=kT+τ;0≦τ<T., where hₖ is the modulation index for the kth symbol interval, αₖ is the symbol for the kth symbol interval, and q is the continuous phase modulation (CPM) phase response function, and wherein θ_{k-L} represents the contribution for symbols older than L-1.

In another example embodiment, the filter and symbol-rate sampler may be adapted to filter and then symbol rate sample the continuous time signal to generate a symbol-rate statistic that is a sufficient statistic to represent the continuous time signal for each of the symbol intervals, the symbol-rate statistic being generated approximately based on the following:

$$\begin{matrix}{x}_{k} = \frac{{\int }_{0}^{T} {φ}_{k} ( τ ; α ) q ( τ ) d τ}{{\int }_{0}^{T} q ( τ ) d τ} \\ = {θ}_{k - L} + \frac{2 π {\sum }_{i = 0}^{L - 1} {h}_{k - i} {α}_{k - i} {\int }_{0}^{T} q ( τ + i T ) q ( τ ) d τ}{{\int }_{0}^{T} q ( τ ) d τ} ,\end{matrix}$$

where φₖ(τ;α) is the continuous time signal, hₖ is the modulation index for the kth symbol interval, αₖ is the symbol for the kth symbol interval, and q is the continuous phase modulation (CPM) phase response function.

In an example embodiment, the transmitter circuit may include a Fourier transform block adapted to perform a Fourier transform on the plurality of constant modulus CPM symbols to generate a group of Fourier coefficients; a subcarrier mapping block adapted to map each of the Fourier coefficients to an orthogonal subcarrier; an inverse Fourier transform block adapted to perform an inverse Fourier transform on the mapped discrete Fourier coefficients to generate a group of time domain samples; and a radio transmitter adapted to transmit the group of time domain samples.

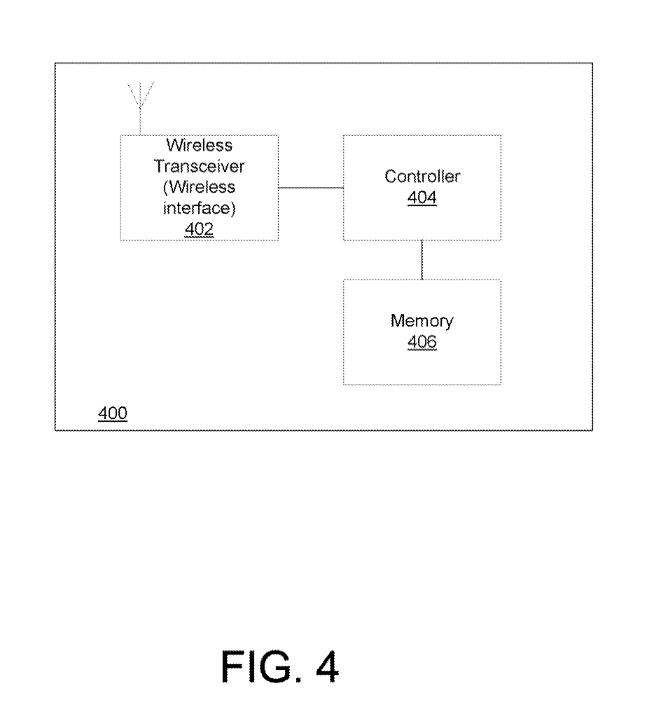

FIG. 4 is a block diagram of a wireless node according to an example embodiment. The wireless node 400 may include a wireless transceiver 402, and a controller 404, and a memory 406. A wireless transmitter 410 may include transceiver 402 and/or controller 404. For example, some operations illustrated in other FIGs. and/or described herein may be performed by a controller 404, under control of software or firmware, for example.

In addition, a storage medium may be provided that includes stored instructions, which when executed by a controller or processor may result in a controller, or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

OFDM: Orthogonal Frequency Division Multiplexing

OFDMA: Orthogonal Frequency Division Multiple Access

CPM: Continuous Phase Modulation

PAPR: Peak-to-Average-Power Ratio

WiMAX: Worldwide Interoperability for Microwave Access

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
generating a continuous time signal based on a symbol and a corresponding modulation index for a current symbol interval and one or more previous symbol intervals and based on a continuous phase modulation (CPM) phase response function;
filtering and then symbol rate sampling the continuous time signal to generate a symbol-rate statistic that is representative of the continuous time signal for each of the symbol intervals;
mapping each of the plurality of symbol-rate statistics to a corresponding constant modulus CPM symbol; and
transmitting a signal based on the constant modulus CPM symbols.

2. The method of claim 1 wherein the generating a continuous time signal comprises generating a continuous time signal based on a sum of products over a range of symbol intervals, where each product is a product of a symbol and a corresponding modulation index and the continuous phase modulation (CPM) phase response function.

3. The method of claim 1 wherein the generating a continuous time signal comprises generating a continuous time signal based approximately on the following equation:
$${φ}_{k} ( t ; α ) = {θ}_{k - L} + 2 π {\sum }_{i = 0}^{L - 1} {h}_{k - i} {α}_{k - i} q ( τ + i T ) ;$$
t=kT+τ;0≦τ<T., where hk is the modulation index for the kth symbol interval, αₖ is the symbol for the kth symbol interval, and q is the continuous phase modulation (CPM) phase response function, and wherein θ_{k-L} represents the contribution for symbols older than L-1.

4. The method of claim 1 wherein a constant modulation index is used for a plurality of symbol intervals.

5. The method of claim 1 wherein a different modulation index is used for each of a plurality of symbol intervals.

6. The method of claim 1 wherein the filtering comprises correlating the continuous time signal against the CPM phase response to generate a filtered signal.

7. The method of claim 1 wherein the filtering comprises filtering and then symbol rate sampling the continuous time signal to generate a symbol-rate statistic that is representative of the continuous time signal for each of the symbol intervals, the filtering being performed using a filter that is substantially matched to the CPM phase response function.

8. The method of claim 1 wherein the filtering and then symbol rate sampling being performed approximately based on the following:
$$\begin{matrix}{x}_{k} = \frac{{\int }_{0}^{T} {φ}_{k} ( τ ; α ) q ( τ ) d τ}{{\int }_{0}^{T} q ( τ ) d τ} \\ = {θ}_{k - L} + \frac{2 π {\sum }_{i = 0}^{L - 1} {h}_{k - i} {α}_{k - i} {\int }_{0}^{T} q ( τ + i T ) q ( τ ) d τ}{{\int }_{0}^{T} q ( τ ) d τ} ,\end{matrix}$$
where φₖ(t;α) is the continuous time signal, hₖ is the modulation index for the kth symbol interval, αₖ is the symbol for the kth symbol interval, and q is the continuous phase modulation (CPM) phase response function.

9. The method of claim 1 wherein the transmitting comprises transmitting an signal including a plurality of orthogonal frequency division multiplexed (OFDM) subcarriers based on the plurality of constant modulus CPM symbols.

10. The method of claim 1 wherein the transmitting comprises:
performing a Fourier transform on the plurality of constant modulus CPM symbols to generate a group of Fourier coefficients;
mapping each of the Fourier coefficients to an orthogonal subcarrier;
performing an inverse Fourier transform on the mapped Fourier coefficients to generate a group of time domain samples; and
transmitting the group of time domain samples.

11. The method of claim 1 and further comprising mapping one or more data bits to a symbol for each of the symbol intervals.

12. An apparatus comprising:
a phase encoder adapted to generate a continuous time signal based on a symbol and a corresponding modulation index for a current symbol interval and one or more previous symbol intervals and based on a continuous phase modulation (CPM) phase response function;
a filter and symbol-rate sampler adapted to filter and then symbol rate sample the continuous time signal to generate a symbol-rate statistic that is representative of the continuous time signal for each of the symbol intervals;
a mapping circuit adapted to map each of the plurality of symbol-rate statistics to a corresponding constant modulus CPM symbol; and
a transmitter circuit adapted to transmit a signal based on the constant modulus CPM symbols.

13. The apparatus of claim 12 wherein the filter and symbol-rate sampler comprises:
a filter adapted to filter the continuous time signal to generate a filtered signal;
a sample and hold circuit adapted to sample the filtered signal at each of a plurality of symbol intervals to generate a symbol-rate statistic for each of the symbol intervals, each symbol-rate statistic representing the continuous time signal for one of the symbol intervals.

14. The apparatus of claim 12 wherein the filter and symbol-rate sampler comprises:
a filter substantially matched to the CPM phase response, the filter adapted to filter the continuous time signal using generate a filtered signal;
a sample and hold circuit adapted to sample the filtered signal at each of a plurality of symbol intervals to generate a symbol-rate statistic for each symbol interval, each symbol-rate statistic being a sufficient statistic to represent the continuous time signal for one of the symbol intervals.

15. The apparatus of claim 12 wherein a different modulation index is used for each of a plurality of symbol intervals.

16. The apparatus of claim 12 wherein the phase encoder comprises a phase encoder adapted to generate a continuous time signal based on a sum of products over a range of symbol intervals, where each product is a product of a symbol and a corresponding modulation index for a symbol interval and based on a continuous phase modulation (CPM) phase response function.

17. The apparatus of claim 12 wherein the phase encoder comprises a phase encoder adapted to generate continuous time signal based approximately on the following equation:
$${φ}_{k} ( t ; α ) = {θ}_{k - L} + 2 π {\sum }_{i = 0}^{L - 1} {h}_{k - i} {α}_{k - i} q ( τ + i T ) ;$$
t=kT+τ;0≦τ<T., where hk is the modulation index for the kth symbol interval, αₖ is the symbol for the kth symbol interval, and q is the continuous phase modulation (CPM) phase response function, and wherein θ_{k-L} represents the contribution for symbols older than L-1.

18. The apparatus of claim 12 wherein the filter and symbol-rate filter and symbol-rate sampler are adapted to filter and then symbol rate sample the continuous time signal to generate a symbol-rate statistic that is a sufficient statistic to represent the continuous time signal for each of the symbol intervals, the symbol-rate statistic being generated approximately based on the following:
$$\begin{matrix}{x}_{k} = \frac{{\int }_{0}^{T} {φ}_{k} ( τ ; α ) q ( τ ) d τ}{{\int }_{0}^{T} q ( τ ) d τ} \\ = {θ}_{k - L} + \frac{2 π {\sum }_{i = 0}^{L - 1} {h}_{k - i} {α}_{k - i} {\int }_{0}^{T} q ( τ + i T ) q ( τ ) d τ}{{\int }_{0}^{T} q ( τ ) d τ} ,\end{matrix}$$
where φₖ (t;α) is the continuous time signal, hₖ is the modulation index for the kth symbol interval, αₖ is the symbol for the kth symbol interval, and q is the continuous phase modulation (CPM) phase response function.

19. The apparatus of claim 12 wherein the transmitter circuit comprises:
a Fourier transform block adapted to perform a Fourier transform on the plurality of constant modulus CPM symbols to generate a group of Fourier coefficients;
a subcarrier mapping block adapted to map each of the Fourier coefficients to an orthogonal subcarrier;
an inverse Fourier transform block adapted to perform an inverse Fourier transform on the mapped discrete Fourier coefficients to generate a group of time domain samples; and
a radio transmitter adapted to transmit the group of time domain samples.
